(19) United States
(12) Patent Application Publication
(10) Pub. No.: US 2006/0137715 A1
(43) Pub. Date: Jun. 29, 2006

(54) Cleaning method for removing copper-based foreign particles

(75) Inventor: Byoung-Yoon Seo, Yeoju-gun (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: DongbuAnam Semiconductor Inc., Seoul (KR)

(21) Appl. No.: 11/318,507

(22) Filed: Dec. 28, 2005

(30) Foreign Application Priority Data
Dec. 28, 2004 (KR) 10-2004-0114088

(51) Int. Cl. B08B 7/00

(52) U.S. Cl. 134/6

(57) ABSTRACT

A cleaning method for removing copper-based foreign particles from a wafer. The method includes changing the zeta-potential of the copper-based foreign particles to negative and removing the copper-based foreign particles having negative zeta-potential by spin-scrubbing. Consequently, the quality of the semiconductor device and the yield thereof can be increased.

### CROSS-REFERENCE TO RELATED APPLICATION

This application claims priority to and the benefit of Korean Patent Application No. 10-2004-0114088 filed in the Korean Intellectual Property Office on Dec. 28, 2004, the entire contents of which are incorporated herein by reference.

### BACKGROUND OF THE INVENTION

(a) Field of the Invention

The present invention relates to a cleaning method for removing copper-based foreign particles. More particularly, the present invention relates to a cleaning method for removing copper-based foreign particles from a copper layer in a semiconductor device manufacturing process.

(b) Description of the Related Art

FIG. 1 is a cross-sectional view showing copper-based foreign particles on a copper layer in a conventional manufacturing process, and FIG. 2 is a picture showing an example of copper-based foreign particles.

Referring to FIG. 1, in a conventional manufacturing process for a semiconductor device, a source/drain and a gate are formed in an active region on a silicon substrate 111 provided with an isolation layer 112, and a silicide layer 113 is formed thereon. For forming a contact, IMD oxide layers 114 and 115 are formed, via holes and trenches are formed, and barrier metals 116 are deposited thereon. Subsequently, the via holes and trenches are filled with metal materials.

A copper layer 117 is formed on the filling metal material for metallization, and after deposition thereof, it is planarized by chemical-mechanical polishing (CMP). However, copper-based foreign particles 118 may remain on the surface of the copper layer 117 after such a process. Reference character “A” in FIG. 2 denotes a defect of the copper-based foreign particles 118.

Therefore, a cleaning process for removing the foreign particles 118 should follow.

A conventional cleaning process for removing the copper-based foreign particles 118 from the copper layer 117 in a semiconductor device may be performed by the following method.

First, a rough cleaning process is performed using an appropriate chemical polishing material, an example thereof being a product with the brand name Buffer Step. Subsequently, after spin scrubber cleaning, megasonic cleaning is performed.

However, the conventional cleaning process for removing the copper-based foreign particles from the copper layer may not completely remove the particles.

The above information disclosed in this Background section is only for enhancement of understanding of the background of the invention and therefore it may contain information that does not form part of the prior art with respect to the present invention.

### SUMMARY OF THE INVENTION

The present invention has been made in an effort to provide a cleaning method having advantages of effectively removing copper-based foreign particles from a copper layer in a semiconductor device manufacturing process.

An exemplary cleaning method for removing copper-based foreign particles according to an embodiment of the present invention includes changing the zeta-potential of the particles to negative and removing the negative zeta-potential particles by spin-scrubbing.

In a further embodiment, in the changing of the zeta-potential of the copper-based foreign particles to negative, if the zeta-potential of a copper layer or an intermetal dielectric layer is positive, the zeta-potential of the surface of the copper layer or intermetal dielectric layer can be changed to negative.

In a further embodiment, in the changing zeta-potential of the copper-based foreign particles to negative, a corrosion inhibitor can be additionally used for slowing the surface corrosion rate of the copper layer.

In a further embodiment, an alkali solution can be used for the changing of the zeta-potential of the copper-based foreign particles to negative.

The alkali solution can be an ammonium hydroxide (NH₄OH) solution or a tetra methyl ammonium hydroxide (TMAH) solution.

The TMAH alkali solution is formed by diluting the TMAH at a ratio of 30:1100 for TMAH:H₂O at room temperature.

In a further embodiment, the process for changing the zeta-potential of the copper-based foreign particles to negative can be performed at a temperature of 25-50° C.

In a further embodiment, deionized water containing CO₂ can be used when removing the copper-based foreign particles by spin-scrubbing.

According to the present invention, when copper-based foreign particles having a positive (+) zeta-potential exist on a wafer surface, their zeta-potential is changed to negative, and they can then be removed from the wafer. Consequently, the quality of the semiconductor device and the yield thereof can be increased.

### BRIEF DESCRIPTION OF THE DRAWINGS

FIG. 1 is a cross-sectional view showing copper-based foreign particles on a copper layer in a conventional manufacturing process.

FIG. 2 is a picture showing an example of copper-based foreign particles.

FIG. 3 is a cross-sectional view for describing a method for removing copper-based foreign particles according to an exemplary embodiment of the present invention.

FIG. 4 is a process flowchart showing a method for removing copper-based foreign particles according to an exemplary embodiment of the present invention.

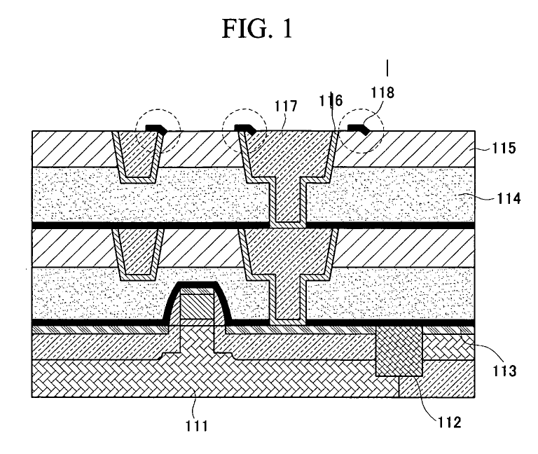

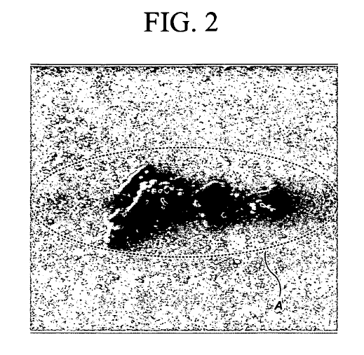

### DETAILED DESCRIPTION OF THE EMBODIMENTS

An exemplary embodiment of the present invention will hereinafter be described in detail with reference to the accompanying drawings.

When copper-based foreign particles exist on a wafer surface having a positive (+) zeta-potential, an exemplary embodiment of the present invention allows the removal of the particles from the wafer so that the quality of the semiconductor device and the yield thereof can be increased.

The zeta-potential is an index for showing a degree of surface-charge of colloid particles in liquid, that is, an electrical potential at a shear boundary.

In order to facilitate understanding of an exemplary embodiment of the present invention, a double sided scrubber (DSS) method or a megasonic cleaning method as a post-cleaning method of a CMP process will hereinafter be described.

First, the double sided scrubber (DSS) method will be described.

A brush scrubbing method is a conventional method for removing fallout particles on a surface of a substrate. According to the brush scrubbing method, the fallout particles are not removed by direct contact of a brush with the fallout particles, but rather by an attraction power of a liquid film formed between the brush and the fallout particles.

In other words, the brush does not touch the fallout particles or the surface of the substrate, but a liquid film is formed therebetween. The brush acts as a paddle that generates the attraction power for removing the fallout particles.

In the 1970s, hard materials such as nylon were used for the brush, but they have a problem in that they may scratch the surface of the wafer substrate. Therefore, poly-vinyl-alcohol (PVA) has recently been adopted for the brush material. PVA is a soft and ductile material that can remove fallout particles without damaging the wafer surface.

A PVA brush scrubbing method is known as a effective method for not only large particles of over 1 μm, but also for small particles of about 0.12 μm. The PVA brush scrubbing method can be used in a pH range of 2 to 12, and ammonium hydroxide (NH₄OH) is typically used therewith. Further, for removing metal-based fallout particles, hydrogen fluoride (HF) can be additionally used.

A double-sided scrubber (DSS) system, in which both sides of a wafer are scrubbed, is currently widely used. The DSS system includes process variables such as a rotation speed of the brush and the wafer, and a brush pressure on the wafer depending on the location of the brush. For example, when the brush is located at a low position, the pressure on the wafer is increased, and therefore fallout particles on the wafer surface may be effectively removed.

The cleaning mechanism in the DSS system mechanically removes the fallout particles from the wafer surface with the brush, and they are rinsed away with continuously supplied de-ionized water.

In addition, a very effective method for preventing particle-absorption into the wafer surface or the brush can be one in which the zeta-potential thereof is controlled. For example, alumina that is used in a metal-CMP process has a positive (+) zeta-potential, and PVA has a negative (−) zeta-potential.

When a cleaning process is performed in an acid environment, a PVA brush can be contaminated by alumina particles, and therefore the brush can cause particle-contamination of the wafer surface during the cleaning process. On the contrary, in an alkali environment, the PVA brush and the alumina particles have zeta-potentials of the same polarity, so the contamination of the brush can be minimized.

All surfaces of PVA, silicon dioxide (SiO₂), aluminum oxide (Al₂O₃), tungsten (W), and silicon nitride (Si₃N₄) have negative zeta-potentials in an alkali solution, and a diluted ammonium hydroxide (NH₄OH) solution at room temperature is widely used. In addition, an anionic surfactant can be used for preventing re-contamination by foreign particles in a hydrogen fluoride (HF) solution, which is acidic.

Next, the megasonic cleaning method will be described.

The cleaning method using a megasonic system adopts a conventional wet cleaning method, and it is a non-contact cleaning method that removes foreign particles by megasonic power. The megasonic cleaning method uses a physical and chemical effect caused by cavitation, acoustic streaming, and radiation force.

However, the particle-removal mechanism of the megasonic cleaning method has not been clearly understood. Thus far, it is known that a cleaning mechanism using a frequency of less than 1 MHz using cavitation of bubbles has a drawback of damage to wafer surfaces. In addition, it is known that a cleaning mechanism using a frequency of 1 MHz using acoustic streaming and radiation force can effectively remove foreign particles on the wafer surface without damage thereto.

Generally, megasonic energy is generated from a piezoelectric transducer located in a lower part of a cleaning bath. The energy generates a pressure wave in a longitudinal direction in a cleaning solution.

The acoustic streaming that is generated by acoustic waves of the solution can be classified into three groups. Rayleigh streaming is generated at the exterior of an acoustic boundary layer from a standing wave in a tube or liquid path, Eckart streaming is generated at a free and irregular acoustic region, and boundary layer streaming is generated by interaction between acoustic flow and barriers. The speed of the flow is increased in proportion to the frequency and power of the acoustic wave, and is decreased in proportion to the viscosity of the solution.

In addition, one of the most important characteristics of megasonic cleaning is that the acoustic boundary layer is much narrower than a typical hydrodynamic boundary layer having the same speed. Therefore, very small foreign particles on the wafer surface are exposed to the flow having a higher speed, so the removal efficiency of the foreign particles can be increased. As described above, in the megasonic cleaning method, the removal efficiency of the foreign particles is related to the boundary thickness. In an actual post-cleaning process of a CMP process, processing wafers are dipped in an SC1 (NH₄OH/H₂O₂/H₂O) or ammonium hydroxide (NH₄OH) solution and they have megasonic energy of 700-1500 kHz applied thereto. The concentration of ammonia should be controlled in order to control the pH of the solution, which is important for controlling the zeta-potential and the dissolution speed of the oxide layer.

In the post-cleaning process of a copper CMP process, an ammonia solution can be used, and a diluted hydrogen fluoride (HF) solution can be used with an additional anionic surfactant. The anionic surfactant changes the surface charge of the foreign fallout particles so as to have zeta-potentials of the same polarity, and therefore the re-contamination by foreign particles can be prevented. A corrosion inhibitor should be additionally used for slowing the surface corrosion rate of the copper layer.

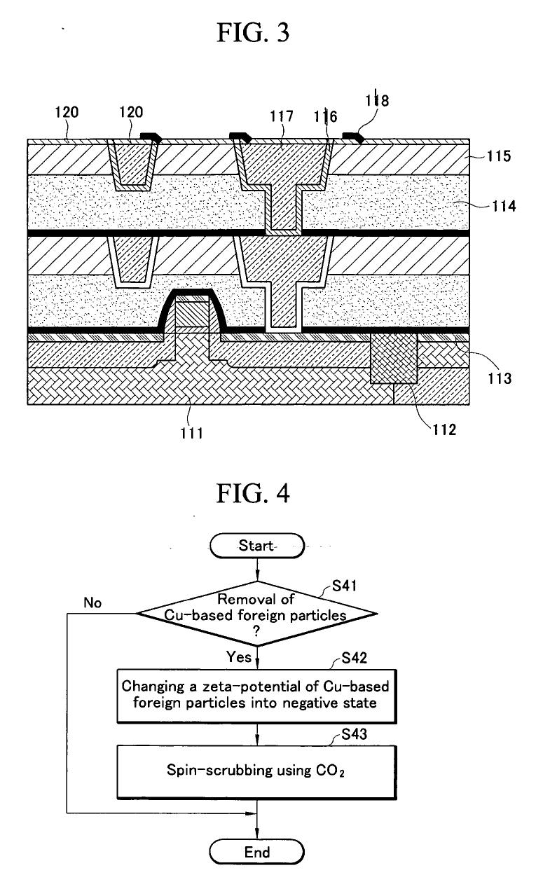

FIG. 3 is a cross-sectional view for describing a method for removing copper-based foreign particles according to an exemplary embodiment of the present invention.

Referring to FIG. 3, as in a typical manufacturing process for a semiconductor device as described above, a source/drain and a gate are formed in an active region on a silicon substrate 111 provided with an isolation layer 112, and a silicide layer 113 is formed thereon. For forming a contact, IMD oxide layers 114 and 115 are formed, via holes and trenches are formed, and barrier metals 116 are deposited thereon. Subsequently, the via holes and trenches are filled with metal materials. A copper layer 117 is formed on the filling metal material for metallization, and after deposition thereof, it is planarized by CMP. However, copper-based foreign particles 118 may remain on the surface of the copper layer 117.

When copper-based foreign particles 118 remain on the wafer surface, the zeta-potential of the copper-based foreign particle 118 is changed to negative. In addition, the zeta-potentials of the surfaces of the copper layer 117 and oxide layer 115 are also changed to negative. The surface layers of the copper layer 117 and oxide layer 115 of which zeta-potentials are changed to negative polarities are shown by reference numeral 120. As described above, when the zeta-potentials of the copper-based foreign particle 118 and the surface layers 120 are changed to negative by an alkali solution, the copper-based foreign particles 118 and the surface layers 120 have zeta-potentials of the same polarity. Consequently, contamination by foreign particles of the wafer surface can be suppressed.

FIG. 4 is a process flowchart showing a method for removing copper-based foreign particles according to an exemplary embodiment of the present invention.

An exemplary cleaning method for removing copper-based foreign particles according to an embodiment of the present invention will hereinafter be described in detail with reference to FIG. 4. At step S41, if copper-based foreign particles are to be removed, the zeta-potential of the particles are changed to negative in order to remove them, at step S42.

If the zeta-potential of a copper layer or an intermetal dielectric layer is positive, the zeta-potential of the copper layer or the intermetal dielectric layer can be changed to negative. An alkali solution can be used for the changing of the zeta-potential of the copper-based foreign particles to negative.

The alkali solution can be an ammonium hydroxide (NH₄OH) solution or a tetra methyl ammonium hydroxide (TMAH) solution. For example, the TMAH alkali solution can be formed by diluting TMAH at a ratio of 30:1100 to produce TMAH:H₂O, at room temperature.

A corrosion inhibitor can be additionally used for slowing the surface corrosion rate of the copper layer.

Subsequently, at step S43, the copper-based foreign particles having a negative zeta-potential are removed by spin-scrubbing. Deionized water (DIW) containing CO₂ can be used in the spin-scrubbing process.

According to the exemplary embodiment of the present invention, the zeta-potential of the copper-based foreign particles is changed to negative and the particles are removed by spin-scrubbing using a DIW containing CO₂, so the copper-based foreign particles can be removed from the patterned copper layer. Consequently, the wafer can have a clean surface.

According to the present invention, when copper-based foreign particles having a positive (+) zeta-potential exist on a wafer, their zeta-potential is changed to negative, and they can then be removed from the wafer. Therefore, the quality of the semiconductor device and the yield thereof may be increased.

While this invention has been described in connection with what is presently considered to be practical exemplary embodiments, it is to be understood that the invention is not limited to the disclosed embodiments, but, on the contrary, it is intended to cover various modifications and equivalent arrangements included within the spirit and scope of the appended claims.

What is claimed is:

1. A cleaning method for removing copper-based foreign particles, comprising:
changing zeta-potential of the copper-based foreign particles to negative; and
removing the copper-based foreign particles having the negative zeta-potential by spin-scrubbing.

2. The cleaning method of claim 1, wherein in the changing of the zeta-potential of the copper-based foreign particles to negative, if the zeta-potential of a copper layer or an intermetal dielectric layer is positive, the zeta-potential of the surface of the copper layer or intermetal dielectric layer is changed to negative.

3. The cleaning method of claim 1, wherein in the changing of the zeta-potential of the copper-based foreign particles to negative, a corrosion inhibitor is additionally used for slowing the surface corrosion rate of the copper layer.

4. The cleaning method of claim 1, wherein an alkali solution is used for the changing of the zeta-potential of the copper-based foreign particles to negative.

5. The cleaning method of claim 4, wherein the alkali solution is an ammonium hydroxide (NH₄OH) solution or a tetra methyl ammonium hydroxide (TMAH) solution.

6. The cleaning method of claim 5, wherein the TMAH alkali solution is formed by diluting the TMAH at a ratio of 30:1100 to produce TMAH:H₂O, at room temperature.

7. The cleaning method of claim 1, wherein the process for changing the zeta-potential of the copper-based foreign particles to negative is performed at a temperature of 25-50° C.

8. The cleaning method of claim 1, wherein deionized water containing CO₂ is used for the removing of the copper-based foreign particles by spin-scrubbing.
